(19) United States
(12) Patent Application Publication
(10) Pub. No.: US 2026/0128859 A1
(43) Pub. Date: May 7, 2026

(54) ELECTRONIC APPARATUS AND CONTROL METHOD THEREOF

(71) Applicant: CRYPTO LAB INC., Seoul (KR)

(72) Inventors: Taeyeong Noh, Seoul (KR); Jaehyung Kim, Stanford, CA (US)

(21) Appl. No.: 19/336,696

(22) Filed: Sep. 23, 2025

(30) Foreign Application Priority Data
Sep. 23, 2024 (KR) 10-2024-0128073
Oct. 2, 2024 (KR) 10-2024-0134096
Sep. 15, 2025 (KR) 10-2025-0131466

(51) Int. Cl. H04L 9/06

(52) U.S. Cl. CPC H04L 9/0637

(57) ABSTRACT

Disclosed is an electronic apparatus. The electronic apparatus includes memory storing instructions, and at least one processor including processing circuitry, the at least one processor configured to obtain a Cheon-Kim-Kim-Song (CKKS) ciphertext encoding a real-number message in a predetermined discrete value set, perform SlotToCoeff computation of converting the real-number message into a coefficient expression, perform, based on modulus switching computation with respect to the ciphertext converted into a coefficient expression, discretization of approximating the real-number message converted into a coefficient expression to a closest value in the predetermined discrete value set, perform modulus raising computation of raising modulus to an upper level with respect to the discretized ciphertext, perform CoeffToSlot computation of converting the ciphertext of which modulus is raised into a slot-encoded message, and perform, based on EvalMod computation, modular reduction at the same time as rebooting computation ends with respect to the slot-encoded ciphertext.

### TECHNICAL FIELD

This disclosure relates to an electronic apparatus and a control method thereof, and more particularly, to an electronic apparatus performing modular reduction and a control method thereof.

### BACKGROUND ART

With the advancement in electronic technologies, various types of electronic apparatuses have been developed. In particular, as most communication technologies are advanced, technologies for encryption/decryption have been recently developed to secure information security.

As a message encrypted based on an encryption technology is delivered to a counterpart, the counterpart needs to perform decryption to use the message. In this case, the process of decrypting encrypted data may cause a waste of resources and time. Additionally, in the state where the message is decrypted temporarily for computation, the decrypted message may be exposed to hacking.

To solve the problem, research into homomorphic encryption has been conducted. The homomorphic encryption (HE) may obtain a result identical with a result that is encrypted after computation of a plaintext, although the computation is performed by using a ciphertext itself without decrypting encrypted information. In other words, the homomorphic encryption may involve various types of computation in the state where a ciphertext is not decrypted.

However, since the CKKS scheme cannot perform discrete computation directly, the CKKS scheme uses a polynomial approximation method, but there may be functions that are hardly polynomial-approximated. Accordingly, there is a problem that the CKKS scheme is limitedly operable only in a small range, and its performance significantly deteriorates with respect to big integers or in a wide real-number range.

### DISCLOSURE OF INVENTION

### Solution to Problem

According to one embodiment, an electronic apparatus may include memory storing instructions, and at least one processor including processing circuitry, the at least one processor configured to obtain a Cheon-Kim-Kim-Song (CKKS) ciphertext encoding a real-number message in a predetermined discrete value set, perform SlotToCoeff computation of converting the real-number message into a coefficient expression, perform, based on modulus switching computation with respect to the ciphertext converted into a coefficient expression, discretization of approximating the real-number message converted into a coefficient expression to a closest value in the predetermined discrete value set, perform modulus raising computation of raising modulus to an upper level with respect to the discretized ciphertext, perform CoeffToSlot computation of converting the ciphertext of which modulus is raised into a slot-encoded message, and perform, based on EvalMod computation, modular reduction at the same time as rebooting computation ends with respect to the slot-encoded ciphertext.

Additionally, the at least one processor may convert first modulus into second modulus lower than the first modulus with respect to the ciphertext converted into a coefficient expression, and restore the second modulus to the first modulus to perform discretization.

Additionally, the at least one processor may perform the discretization to obtain an output message in the predetermined discrete value set.

Additionally, the at least one processor may perform computation with respect to the output message through a look-up table without polynomial approximation at a time of additional function computation.

Additionally, the at least one processor may perform bit decomposition with respect to the output message to perform discrete function computation with respect to the output message.

Additionally, the electronic apparatus may further include a communication interface, and the at least one processor may control the communication interface to transmit the output message to a server.

Additionally, the electronic apparatus may further include a display, and the at least one processor may control the display to display the output message.

Further, a scaling factor of the real-number message may be maintained at a first modulus value while the modular reduction is performed.

Meanwhile, according to one embodiment, a control method of an electronic apparatus may include obtaining a Cheon-Kim-Kim-Song (CKKS) ciphertext encoding a real-number message in a predetermined discrete value set, performing SlotToCoeff computation of converting the real-number message into a coefficient expression, performing, based on modulus switching computation with respect to the ciphertext converted into a coefficient expression, discretization of approximating the real-number message converted into a coefficient expression to a closest value in the predetermined discrete value set, performing modulus raising computation of raising modulus to an upper level with respect to the discretized ciphertext, performing CoeffToSlot computation of converting the ciphertext of which modulus is raised into a slot-encoded message, and performing, based on EvalMod computation, modular reduction at the same time as rebooting computation ends with respect to the slot-encoded ciphertext.

Additionally, the performing discretization may include converting first modulus into second modulus lower than the first modulus with respect to the ciphertext converted into a coefficient expression, and restoring the second modulus to the first modulus to perform discretization.

Additionally, the method may further include performing the discretization to obtain an output message in the predetermined discrete value set.

Additionally, the method may further include performing computation with respect to the output message through a look-up table without polynomial approximation at a time of additional function computation.

Additionally, the method may further include performing bit decomposition with respect to the output message to perform discrete function computation with respect to the output message.

Additionally, the method may further include transmitting the output message to a server.

Additionally, the method may further include displaying the output message.

Further, scaling factor of the real-number message may be maintained at a first modulus value while the modular reduction is performed.

According to one embodiment, in a non-transitory computer-readable recording medium storing a program for executing an operation method of an electronic apparatus, the operation method may include obtaining a Cheon-Kim-Kim-Song (CKKS) ciphertext encoding a real-number message in a predetermined discrete value set, performing SlotToCoeff computation of converting the real-number message into a coefficient expression, performing, based on modulus switching computation with respect to the ciphertext converted into a coefficient expression, discretization of approximating the real-number message converted into a coefficient expression to a closest value in the predetermined discrete value set, performing modulus raising computation of raising modulus to an upper level with respect to the discretized ciphertext, performing CoeffToSlot computation of converting the ciphertext of which modulus is raised into a slot-encoded message, and performing, based on EvalMod computation, modular reduction at the same time as rebooting computation ends with respect to the slot-encoded ciphertext.

### BRIEF DESCRIPTION OF DRAWINGS

FIG. 1 is a view provided to explain a structure of a network system according to one embodiment;

FIG. 2 is a view provided to explain a structure of a network system according to one embodiment;

FIG. 3 is a block diagram illustrating a configuration of an electronic apparatus according to one embodiment;

FIG. 4 is a view illustrating a summary of performance of iterative MSB bootstrapping and homomorphic modular reduction with respect to integers and real numbers according to one embodiment;

FIG. 5 is a view provided to explain algorithm 1 according to one embodiment;

FIG. 6 is a view provided to explain algorithm 2 according to one embodiment;

FIG. 7 is a view provided to explain algorithm 3 according to one embodiment;

FIG. 8 is a view provided to explain algorithm 4 according to one embodiment;

FIG. 9 is a view provided to explain algorithm 5 according to one embodiment;

FIG. 10 is a view provided to explain algorithm 6 according to one embodiment;

FIGS. 11-17 are views provided to explain performance according to one embodiment; and

FIG. 18 is a flowchart provided to explain a control method of an electronic apparatus according to one embodiment.

### MODE FOR INVENTION

Hereafter, the subject matter of the present disclosure is described in detail with reference to the accompanying drawings.

General terms currently used as widely as possible are selected as the terms used to describe the embodiments of the disclosure considering functions in the disclosure, but may be changed based on the intention of those skilled in the art or a judicial precedent, the emergence of a new technology, or the like. Additionally, in a certain case, terms arbitrarily chosen by the applicant may be included in the terms used herein. In this case, the meanings of such terms are described in detail in corresponding descriptions of the disclosure. Accordingly, the terms used in the disclosure need to be defined based on the meanings thereof and particulars throughout the disclosure rather than the names thereof.

In the disclosure, the expression “have”, “may have”, “include”, “may include” or the like, indicates the existence of a corresponding feature (e.g., a numerical value, a function, an operation or an element such as a part and the like), and does not exclude the existence of an additional feature.

The expression of at least one from A or/and B is to be understood as indicating any one of “A” or “B” or “A and B”.

The expression “1st”, “2nd”, “first”, “second”, or the like, used in the disclosure, may be used to refer to various elements regardless of their order and/or importance, and may be used merely to differentiate one element from another but not intended to limit the elements.

In the disclosure, singular forms include plural forms as well, unless explicitly indicated otherwise. In the disclosure, the term “include,” “comprised of” or the like specifies the presence of stated features, numbers, steps, operations, elements, parts or combinations thereof, but does not imply the exclusion of the presence or addition of one or more other features, numbers, steps, operations, elements, parts or combinations thereof.

In the disclosure, the term user may refer to a person who uses an electronic apparatus or an apparatus (e.g., an artificial intelligence electronic apparatus) that uses an electronic apparatus.

Hereafter, various embodiments according to the disclosure are described in greater detail with reference to the accompanying drawings.

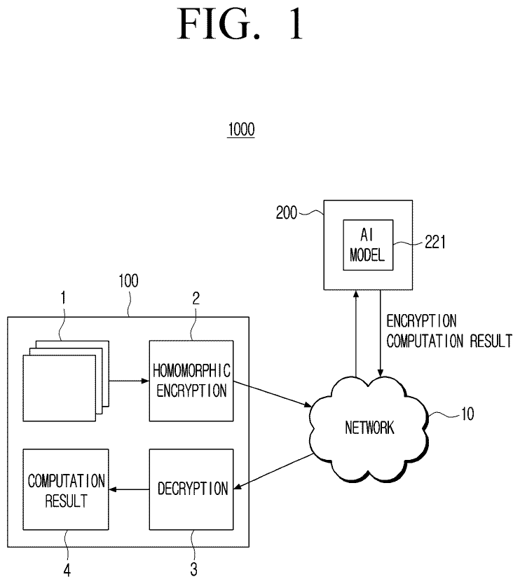

FIG. 1 is a view provided to explain a structure of a network system 1000 according to one embodiment.

Referring to FIG. 1, an electronic apparatus 100 and a server 200 may communicate with each other through a network 10. The network 10 may be implemented as various types of wired/wireless communication networks, broadcast communication networks, optical communication networks, cloud networks and the like, and each of the devices may also be connected based on methods such as Wi-Fi, Bluetooth, Near Field Communication (NFC) and the like, without a separate medium.

FIG. 1 illustrates one electronic apparatus 100, but the electronic apparatus 100 may be implemented in various different forms. As one example, the electronic apparatus 100 may be various types of apparatuses such as a smartphone, a tablet, a PC, a laptop PC, a home server, a kiosk, a game console, a camera and the like. In addition, the electronic apparatus 100 may also be implemented in the form of a home appliance to which IoT functions are applied.

As one example, in the case where the electronic apparatus 100 is provided with a camera, the electronic apparatus 100 may capture an image of at least one original data 1 directly and obtain the image. In the case where the electronic apparatus 100 is provided with no camera, the electronic apparatus 100 may receive original data 1 through various types of wired or wireless interfaces from an external device (e.g., a camera, a memory stick and the like) and store the original data. In the embodiments of the disclosure, the original data 1 may be a photo image, but not necessarily limited thereto, and may be a graphic image. Alternatively, the original data 1 may be video contents including a plurality of image frames.

The electronic apparatus 100 may perform homomorphic encryption 2 with respect to at least one original data, obtain a homomorphic ciphertext, and then transmit the homomorphic ciphertext to the server 200 through the network 10.

In this case, the leakage of the original data 1 may be caused due to hacking, or by a manager of the server 200, in the process of transmission. However, in the case where the original data are transmitted in the form of a homomorphic ciphertext, the original data may not be identified despite the leakage of the original data. Accordingly, security associated with the user's personal information or physical feature may improve.

A homomorphic encryption algorithm generating a homomorphic ciphertext may vary, but in the embodiments of the disclosure, performing homomorphic encryption by using a CKKS scheme or a CKKS scheme-based modified algorithm is described.

To transmit the original data in the form of a homomorphic ciphertext, the electronic apparatus 100 may perform encoding. In the case of homomorphic encryption, encoding may be a task of converting data into an encryptable form. Since homomorphic encryption is based on a mathematical structure (e.g., poilynomial computation), the homomorphic encryption algorithm may convert the original data 1 to a processible form, and then perform homomorphic encryption of the original data.

In the homomorphic encryption, slot encoding and coefficient encoding may be ordinarily used.

The slot encoding is a method by which data to be encrypted are allocated to a plurality of slots, and then encrypted based on a total slot unit. The slot may mean a unit of data that can be stored in parallel in one homomorphic ciphertext. In the case where a ciphertext is expressed in the form of a polynomial, coefficients or roots of the polynomial may function as each slot. If one ciphertext is comprised of a total of n numbers of slots, n numbers of values may be encrypted or computed at the same time. In other words, as slot encoding is performed, parallel computation with respect to a homomorphic ciphertext may be performed. The slot encoding method may vary depending on a homomorphic encryption algorithm. The above-described CKKS scheme may perform slot encoding by using Fast Fourier Transform (FFT).

The coefficient encoding is a method by which data to be encrypted is converted in the form of a polynomial, and coefficients of the polynomial are converted into encrypted values. The above-described CKKS scheme may perform coefficient encoding by using Discrete Fourier Transform (DFT).

The server 200 is a device for providing a result of encryption computation by performing computation in the state where a homomorphic ciphertext (i.e., at least one original data homomorphically encrypted) provided from the electronic apparatus 100 is homomorphically encrypted. The server 200 may be implemented in various different forms such as a web server, a cloud server and the like.

In the server 200, an AI model 221 for performing computation in an encryption state may be stored. In the case where original data are provided and computation based on the original data is permed as described above, the AI model 221 may be a convolutional neural network (CNN), but not necessarily limited thereto.

In detail, the AI model 221 may perform various types of computation with respect to a homomorphic ciphertext encrypted with a homomorphic encryption (e.g., a CKKS scheme) technology, and output a result of the computation in the form of a homomorphic ciphertext. Hereafter, a computation result output in the form of a homomorphic ciphertext is referred to as an encryption computation result.

In the case where the AI model 221 is comprised of a CNN, the AI model 221 of the server 200 may perform convolution computation with respect to each depth or convolution computation by using a model parameter with respect to a homomorphic ciphertext transmitted from the electronic apparatus 100. Such a computation method is described hereafter in detail.

The server 200 may transmit an encryption computation result to the electronic apparatus 100 through the network 100. The electronic apparatus 100 may decrypt 3 the received encryption computation result, and provide a result of the computation 4 to the user. A method of providing the result may vary depending on the sort and configuration of electronic apparatus 100.

As one example, in the case where the electronic apparatus 100 is provided with a built-in display or connected with an externa display (e.g., a monitor), the electronic apparatus 100 may display a decrypted computation result 4.

As one example, in the case where the electronic apparatus 100 is provided with a speaker, the electronic apparatus 100 may also output a voice message corresponding to a computation result through the speaker.

As one example, in the case where the electronic apparatus 100 communicates with another terminal device (e.g., a smartphone and the like), the electronic apparatus 100 may also transmit a decrypted computation result to the terminal device.

As one example, in the case where the AI model 221 is a model trained to diagnose whether there is a disease, a computation result may include information as to where there is a disease, information on the sort of disease, information on the progress of a disease and the like that are diagnosed based on original data 1 of the user.

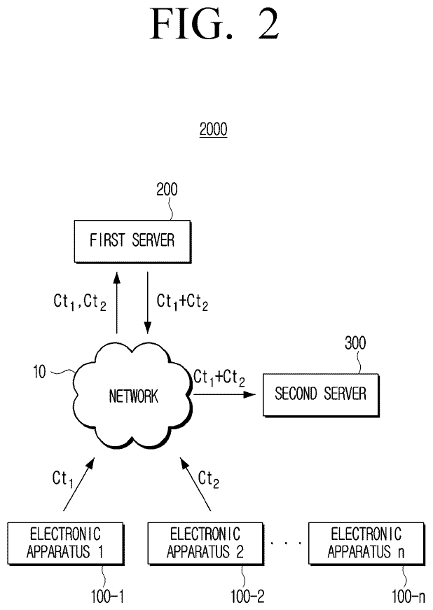

FIG. 2 is a view provided to explain a structure of a network system 2000 according to one embodiment.

Referring to FIG. 2, the network system may include a plurality of electronic apparatuses 100-1-100-n, a first server 200, and a second server 300, and each of the elements may be connected with one another through a network 10.

The network 10 may be implemented as various types of wired/wireless communication networks, broadcast communication networks, optical communication networks, cloud networks and the like, and each of the devices may also be connected based on methods such as Wi-Fi, Bluetooth, Near Field Communication (NFC) and the like, without a separate medium.

FIG. 2 illustrates a plurality of electronic apparatuses 100-1-100-n, but the plurality of electronic apparatuses may not be necessarily used, and one electronic apparatus may be used. As one example, the electronic apparatuses 100-1-100-n may be implemented as various types of apparatuses such as a smartphone, a tablet, a game console, a PC, a laptop PC, a home server, a kiosk, and the like, and in addition, may also be implemented in the form of a home appliance to which IoT functions are applied.

The user may input various types of information through the electronic apparatuses 100-1-100-n used by the user. The input information may be stored in the electronic apparatuses 100-1-100-n themselves, but may be transmitted to an external device and stored in the external device for the reasons of storage capacity and security and the like. In FIG. 2, the first server 200 may play a role in storing the information, while the second server 300 may play a role in using all or part of the information stored in the first server 200.

Each of the electronic apparatuses 100-1-100-n may homomorphically encrypt the input information and transmit a homomorphic ciphertext to the first server 200.

Each of the electronic apparatuses 100-1-100-n may have cryptographic noise, i.e., an error, produced in the process of homomorphic encryption, included in the ciphertext. Specifically, the homomorphic ciphertext generated in each of the electronic apparatuses 100-1-100-n may be generated in the way that a resultant value including a message and an error value is restored at a time when decryption is performed by using a secret key later.

As one example, the homomorphic ciphertext generated in the electronic apparatuses 100-1-100-n may be generated in the way that the following features are satisfied at a time when decryption is performed by using a secret key.

$$Dec ( ct , sk ) = < ct , sk >= M + e ( mod q ) \qquad [ Formula 1 ]$$

Herein, <, > means a usual inner product, ct means a ciphertext, sk means a secret key, M means a plaintext message, e means an encryption error value, and mod q means modulus of a ciphertext. Herein, q needs to be selected as a value greater than M that is a resultant value calculated by multiplying the message by a scaling factor Δ. In the case where an absolute value of error value e is sufficiently less than M, a decryption value M+e of the ciphertext is a value that may replace an original message with precision in significant figure arithmetic. An error in decrypted data may be disposed to the least significant bit (LSB), while M may be disposed to the second least significant bit.

In the case where the size of the message is too small or big, the size may be adjusted by using the scaling factor. In the case of use of a scaling factor, a real number-type message as well as an integer-type message may be encrypted, thereby enhancing availability significantly. Additionally, since the size of the message is adjusted by using the scaling factor, the size of an area where messages are present, i.e., an effective area, in a ciphertext after the performance of computation, may also be adjusted.

According to the embodiment, the ciphertext modulus q may be set in various different forms, for use. As one example, the modulus of the ciphertext may be set in the form of q=Δ^{L} (scaling factor Δ to the power of exponent). In the case where Δ is two, the modulus of the ciphertext may be set to a value such as q=210.

Additionally, the homomorphic ciphertext according to the disclosure is described under the assumption that a fixed point is used, but may be applied even in the case where a floating point is used.

The first server 200 may store a received homomorphic ciphertext in a ciphertext state, without decrypting the ciphertext.

The second server 300 may request a specific processing result of the homomorphic ciphertext from the first server 200. The first server 200 may perform specific computation at the request of the second server 300, and then transmit a result of the computation to the second server 300.

As one example, in the case where ciphertexts ct1, ct2 transmitted by two electronic apparatuses 100-1, 100-2 are stored in the first server 200, and the second server 300 may request a value calculated by adding data provided from the two electronic apparatuses 100-1, 100-2 from the first server 200. The first server 200 may perform computation of adding two ciphertexts at the request of the second server, and then transmit a resultant value ct1+ct2 of the computation to the second server 300.

Considering the attributes of the homomorphic ciphertext, the first sever 200 may perform computation in the state where decryption is not performed, and a resultant value of the computation may also be formed into a ciphertext. In the disclosure, a resultant value obtained based on computation is referred to as a ciphertext.

The first server 200 may transmit the computation result ciphertext to the second server 300. The second server 300 may decrypt the received computation result ciphertext, to obtain a resultant value of computation of data included in each of the homomorphic ciphertexts.

Accordingly, the electronic 100 may perform efficient multiplication computation while minimizing the number of RNS moduli, thereby enabling rapid computation of a homomorphic ciphertext.

Meanwhile, in FIG. 2, first and second electronic apparatuses performing encryption, and the second server performing decryption are illustrated, but not limited thereto.

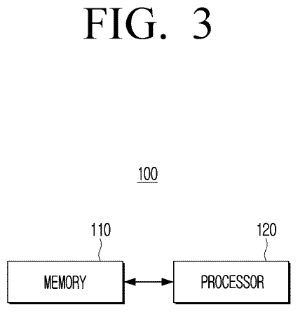

FIG. 3 is a block diagram illustrating a configuration of an electronic apparatus 100 according to one embodiment.

Referring to FIG. 3, an electronic apparatus 100 includes memory 110 storing instructions and at least one processor 120. The at least one processor 120 may execute instructions to perform a following operation.

The memory 110 may refer to hardware storing information such as data and the like in the form of electricity or magnetism, such that the processor 120 and the like may access the information. To this end, the memory 110 may be implemented as at least one hardware out of non-volatile memory, volatile memory, flash memory, hard disk drive (HDD), or solid state drive (SSD), RAM, ROM and the like.

In the memory 110, at least one instruction required for operations of the electronic apparatus 100 or the processor 120 may be stored. Herein, the instruction, as a symbol (sign) unit indicating the operations of the electronic apparatus 100 or the processor 120, may be drawn up in mechanical language as language understandable by a computer. Alternatively, in the memory 110, a plurality of instructions for performing specific tasks of the electronic apparatus 120 or the processor 120 may be stored as an instructions set.

In the memory 110, data as information of a bit unit or a byte unit, which may indicate letters, numbers, videos and the like, may be stored. For example, in the memory 110, data as an encryption target, encrypted data and the like may be stored.

The memory 110 may be accessed by the processor 120, and the processor 120 may perform reading/recording/correcting/deleting/updating and the like of an instruction, an instruction set, or data.

The processor 120 controls the operations of the electronic apparatus 100 entirely. Specifically, the processor 120 may be connected with each of the elements of the electronic apparatus 100 to control the operations of the electronic apparatus 100 entirely. For example, the processor 120 may be connected to the elements such as memory 110 and the like, to control the operations of the electronic apparatus 100.

The one or more processors 120 may include one or more of a central processing unit (CPU), a graphics processing unit (GPU), an accelerated processing unit (APU), many integrated core (MIC), a neural processing unit (NPU), a hardware accelerator or a machine learning accelerator. The one or more processors 120 may control one among other elements of the electronic apparatus 100 or any combination thereof, and perform an operation in association with communication or data processing. The one or more processors 120 may execute one or more programs or instructions stored in the memory 110. For example, the one or more processors 120 may perform a method according to one embodiment, by executing one or more instructions stored in the memory 110.

In the case where the method according to one embodiment includes a plurality of operations, the plurality of operations may be performed by one processor, or by a plurality of processors. For example, when a first operation, a second operation, and a third operation are performed based on the method according to one embodiment, the first operation, the second operation and the third operation may all be performed by a first processor, or the first operation and the second operation may be performed by the first processor (e.g., a general-purpose processor), while the third operation may be performed by a second processor (e.g., an AI-exclusive processor).

The one or more processors 120 may be implemented as a single core processor including one core, or one or more multicore processors including a plurality of cores (e.g., a homogeneous multi core or a heterogeneous multi core). In the case where the one or more processors 120 are implemented as a multicore processor, each of the plurality of cores included in the multicore processor may include processor internal memory such as cache memory, and on-chip memory, and common cache shared by the plurality of cores may be included in the multicore processor. Additionally, each of the plurality of cores (or part of the plurality of cores) included in the multicore processor may read and perform a program instruction for implementing the method according to one embodiment independently or in the way that all (or part) of the plurality of cores are associated.

In the case where the method according to one embodiment includes a plurality of operations, the plurality of operations may be performed by one of the plurality of cores included in the multicore processor or performed by the plurality of cores included in the multicore processor. For example, when a first operation, a second operation, and a third operation are performed based on the method according to one embodiment, the first operation, the second operation and the third operation may all be performed by a first core included in the multicore processor, or the first operation and the second operation may be performed by the first core included in the multicore processor, while the third operation may be performed by a second core included in the multicore processor.

In the embodiments of the disclosure, the one or more processors 120 may mean a system on a chip (SoC) where one or more processors and other electronic components are integrated, a single core processor, a multicore processor, or a core included in a single core processor or a multicore processor, and herein, the core may be implemented as a CPU, a GPU, an APU, a MIC, a NPU, a hardware accelerator, or a machine learning accelerator, and the like, but embodiments thereof may not be limited thereto. Hereafter, the expression processor 120 is used to describe the operations of the electronic apparatus 100 for convenience of description.

The processor 120 may obtain a Cheon-Kim-Kim-Song (CKKS) ciphertext in which a real number-message in a predetermined discrete value set is encrypted, perform SlotToCoeff computation of converting the real number-message into a coefficient expression, perform discretization of approximating the real number-message converted into the coefficient expression to a closest value of the predetermined discrete value set, based on modulus switching computation with respect to the ciphertext converted into the coefficient expression, perform modulus raising computation of raising the modulus to an upper level with respect to a discretized ciphertext, perform CoeffToSlot computation of converting the ciphertext of which the modulus is raised into a slot encoded message, and perform modular reduction at the same time as rebooting computation with respect to the slot encoded ciphertext based on EvalMod computation ends.

That is, the processor 120 may perform modular reduction without existing polynomial approximation as a discretization operation is performed additionally. Additionally, based on modulus switching computation, the processor 120 may round off the real number-message such that the real number-message may correspond to the predetermined discrete value set and convert the real umber-message into a discrete CKKS ciphertext. Then the modular reduction is performed based on CoeffToSlot computation and EvalMod computation, at the same time as bootstrapping is performed, thereby securing computation efficiency.

Additionally, the subject matter of the disclosure may be operated with constant complexity regardless of the size of a message unlike a conventional one, and may secure high performance despite a big (wide) input range. Accordingly, the subject matter of the disclosure may effectively solve problems such as a degree explosion, or a precision loss that occurs in a conventional approximation-based method.

Meanwhile, a scaling factor of the real number-message may be maintained at a first modulus value, while the modular reduction is performed. In other words, since the scaling factor remains the same as a base modulus, modular reduction computation may be performed reliably. A gap between modulus and a scale is required in the case of conventional CKKS, but the processor 120 may perform modular reduction and bootstrapping without a gap.

Accordingly, computation efficiency may be enhanced, an unnecessary precision loss may be prevented, and a calculation resource may be saved.

The processor 120 may convert a first modulus into a second modulus lower than the first modulus with respect to the ciphertext converted into a coefficient expression, and restore the second modulus to the first modulus to perform discretization.

That is, the processor 120 may apply modulus switching two consecutive times. For example, the processor 120 may map the real number-message converted into a coefficient expression in a specific discrete lattice while converting the first modulus into the second modulus lower than the first modulus, and restore the second modulus to the first modulus again to normalize the real number-message to a closest discrete value.

This is enabled only after the real number-message is converted into a coefficient expression based on SlotToCoeff computation, and accordingly, the advantages of discrete CKKS computation may be applied to an ordinary CKKS ciphertext.

The processor 120 may perform discretization to obtain an output message in the predetermined discrete value set. For example, the processor 120 may obtain an output message of a finite set such as {0, 1/32, . . . , 31/32} based on discretization. In other words, the advantages of discrete CKKS may be used through the message, while polynomial interpolation or lookup table-based computation may be enabled.

In particular, sign, abs, max functions and the like hardly approximated with a polynomial may be processed efficiently based on a LUT-based approach.

The processor 120 may perform computation with respect to the output message through a look-up table without polynomial approximation at a time of additional function computation. In other words, since the output message belongs to the finite set, the processor 120 may configure an accurate LUT with respect to any function, and based on the LUT, perform computation.

For example, in existing CKKS, functions such as ReLU, exp, sqrt and the like need to be approximated with a high-degree polynomial, but in the case where the discrete CKKS or LUT method is used, the functions may be calculated efficiently and reliably.

The processor 120 may perform bit decomposition with respect to the output message, to perform discrete function computation with respect to the output message.

The bit decomposition may enable higher-degree computation such as comparison, argmax, sorting and the like in discrete CKKS, and an existing polynomial approximation method requires very deep circuitry and large calculation costs, while the bit decomposition enables such computation to be performed without complexity and with efficiency.

For example, in the case where the bit decomposition is used, the speed of computation performance may be faster up to a maximum of seven times than conventional, and the probability of failure may be reduced to a level almost close to zero.

The electronic apparatus 100 may further include a communication interface, and the processor 120 may control the communication interface to transmit an output message to a server. Since the output message is in the state where homomorphic computation is applied to the output message, the processor 120 may transmit the output message reliably to the server through the communication interface. Accordingly, present disclosure may be useful in an environment where resources are limited such as an IoT device, a mobile device and the like.

The server may preform additional computation or tally processing based on the received output message, and data may be in an encryption state, thereby ensuring security and privacy.

Herein, the communication interface is an element performing communication with various types of external devices based on various communication methods. For example, the electronic apparatus 100 may perform communication with the server through the communication interface.

The communication interface may include a Wi-Fi module, a Bluetooth module, an infrared communication module and a wireless communication module and the like. Herein, each of the communication modules may be implemented in the form of at least one hardware chip.

The Wi-Fi module, and the Bluetooth module perform communication based on a Wi-Fi method and a Bluetooth method respectively. In the case where the Wi-Fi module or the Bluetooth module are used, the Wi-Fi module and the Bluetooth module may perform communication respectively based on a Wi-Fi method and a Bluetooth method. In the case where the Wi-Fi module or the Bluetooth module is used, various types of connection information such as a service set identifier (SSID), a session key and the like may be first transmitted and received, and are used to perform communication connection and then transmit and receive various types of information. The infrared communication module performs communication based on an infrared Data Association (IrDA) communication technology which transmits data wirelessly over a short distance by using infrared rays between visible light and millimeter waves.

The wireless communication module may include at least one communication chip that performs communication according to various wireless communication standards such as Zigbee, 3rd Generation (3G), 3rd Generation Partnership Project (3GPP), Long Term Evolution (LTE), LTE Advanced (LTE-A), 4th Generation (4G), 5th Generation (5G) and the like, in addition to the above-described communication methods.

Alternatively, the communication interface may include a wired communication interface such as a high definition multimedia interface (HDMI), display port (DP), Thunderbolt, universal serial bus (USB), red green blue (RGB), D-subminiature (D-SUB), and digital visual interface (DVI) and the like.

Another communication interface may also include at least one among wired communication modules that perform communication by using a local area network (LAN) module, an Ethernet module, or pair cables, coaxial cables, or fiber optic cables and the like.

The electronic apparatus 100 may further include a display, and the processor 120 may control the display to display an output message. For example, the processor 120 may convert the output message into a form that can be checked by the user directly, and control the display to display the converted output message. For example, the processor 120 may provide sensitive information such as medical data or a personalized analysis result to the user as visual data in the state where the sensitive information is processed reliably.

Such a method may have an advantage of ensuring an immediate check of a result at a local device, and may enhance user experience while securing improvement in data privacy.

The electronic apparatus 100, as described above, may perform modular reduction regardless of an input range, by overcoming a limitation in an existing polynomial approximation method, and accordingly, may support efficient discrete function computation and machine learning computation.

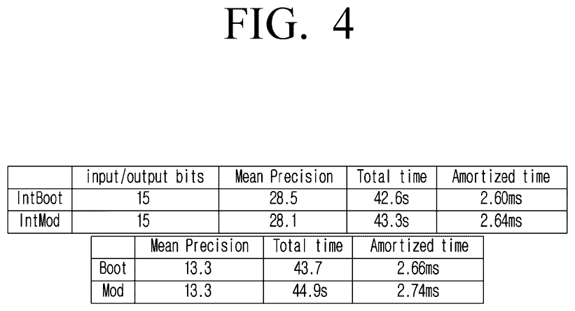

Hereafter, the operations of the electronic apparatus 100 are described in greater detail with reference to FIGS. 4-17. In FIGS. 4-17, individual embodiments are described for convenience of description. However, the individual embodiments of FIGS. 4-17 may also be implemented in any combination.

Among fully homomorphic encryption (FHE) methods, the Cheon-Kim-Kim-Song (CKKS) method [CKKS17] may efficiently provide real number-calculation necessary for various applications such as machine learning. For example, the CKKS may provide a function called rescaling, and the rescaling may be a function of approximately dividing a message by a constant. However, the rescaling may prevent the CKKS from supporting intrinsic modular reduction performed in other main methods (BGV [BGV12], BFV [Bra12, FV12], CGGI [CGGI16], DM [DM15]). Accordingly, the CKKS may process discrete computation (e.g., comparison such as [CKK+19, CKK20, LLKN22, LLKN22]) based on polynomial approximation, but result in relatively low performance.

In the disclosure, efficient discrete computation for the CKKS may be provided by using an inherent modular reduction function in [symbol] _{q}= [symbol] _{q}[X]/(X^{N}+1). In the case of a conventional CKKS, modular reduction may be used in rescaling and ModRaise computation, and in some studies [KDE+24, CCKS23], modular reduction may be partially used to design a new function in the case of CKKS, but research into the effect of modular reduction is not enough. In the disclosure, modular reduction is integrated as part of basic CKKS computation, and the integrated one is used to process discrete calculation.

In the case of [symbol] = [symbol] [X]/(X^{N}+1), [symbol] _{Q}= [symbol] /Q [symbol] when integer N as powers of 2 and Q∈ [symbol] _{>0} are given, modular reduction in [symbol] _{Q} may be inherent. In other words, in the case of q|Q and p(X)∈ [symbol] _{Q}, [p(X)]_{q} may be defined as taking each coefficient q as modulus. In the case where coefficient-encoding RLWE ciphertext

$$ct = ( b , a ) ∈ {ℛ}_{Q}^{2}$$

is given, and this decrypts m∈ [symbol] , the following may be defined.

$${[ ct ]}_{q} = ( {[ b ]}_{q} , {[ a ]}_{q} ) ∈ {ℛ}_{q}^{2}$$

This may be decrypted to [m]_{q}.

However, in conventional CKKS, modular reduction may be used in a limited manner. For example, a CKKS ciphertext is usually in a slot-encoding state, and this is because this is not compatible with modular reduction, and the ciphertext may be in the coefficient-encoding state right over the lowest modulus, immediately before the ModRaise step in the bootstrapping context. Additionally, if decryption is not immediately preformed right after modular reduction, an output of the modular reduction may require bootstrapping for more calculations. However, since a message has a ciphertext having no gap with modulus, bootstrapping may hardly be performed. Existing CKKS bootstrapping (suggested for the first time in [CHK+18]) may calculate approximate modular reduction for removing base modulus of small multiples only in the case where there is a gap between a message and modulus.

The processor 120 may integrate bootstrapping into modular reduction, and use most significant bit (MSB) bootstrapping. For example, the processor 120 may perform bootstrapping each time modular reduction is required, but this may be more excellent than a typical approximation-based method. In the case of MSB bootstrapping, a coefficient-encoding method in [BKSS24] may be adopted, and may be expanded through an iterative algorithm. Hereafter, a MSB bootstrapping framework with respect to discrete data is described, and then variants for real-number data and approximate data are described.

### Iterative MSB Bootstrapping

An iterative MSB bootstrapping method may be a method of expanding a MSB bootstrapping method in [BGGJ20, BKSS24]. The iterative method has a main advantage of securing any precision (e.g., [BCC+22]) which may be necessary for a modular reduction framework described hereafter. In the case where coefficient-encoding RLWE ciphertext

$$ct = ( b , a ) ∈ {ℛ}_{q}^{2}$$

encodes message m∈ [symbol] ₜ_{^{e}} at an upper bit, lowest-level scaling factor. Δ₀ may be set to q₀/ [symbol] The lowest digit number may be extracted sequentially. First, the processor 120 may multiply ct by. [symbol] to obtain a CKKS ciphertext encoding [m]ₜ at the most significant bit. The processor 120 may bootstrap the ciphertext (using integer-to-integer bootstrapping of [BKSS24]) to obtain

$${ct}^{′} ∈ {ℛ}_{Q}^{2}$$

encoding [m]ₜ. The processor 120 may extract a lowest coefficient of ct from lowest modulus. q₀, and deduct the lowest coefficient from an original ciphertext ct. In this process, the processor 120 may obtain a slot-encoding CKKS ciphertext encoding a lowest digit number of m and a coefficient-encoding RLWE ciphertext encoding all the remaining digit numbers (i.e., (m−[m]ₜ)/t) at an upper bit. In one embodiment, the processor 120 may repeat this process to extract all the digit numbers and combine the extracted digit numbers.

### MSB Bootstrapping for Reals

In the case where high-precision MSB bootstrapping with respect to discrete data is given, the processor 120 may use modulus switching to obtain real number-to-real number bootstrapping. For example, in the case where the modulus switching is performed with small modulus, the processor may convert the ciphertext into a discrete-CKKS ciphertext. In other words, in the case where existing coefficient-encoding CKKS ciphertext

$$ct = ( b , a ) ∈ {ℛ}_{q}^{2}$$

encodes vector \vec{z}∈[−1, 1]^{N/2} to scaling factor Δ₀=q₀, changing this to modulus [symbol] and returning to q₀ may be deemed to discretize the ciphertext, and a small error at the least significant bit may be allowed. For example, an output ciphertext encodes plaintext m∈ [symbol] and this may be approximately [symbol] The processor 120 may use interative MSB bootstrapping to bootstrap the ciphertext.

### Homomorphic Modular Reduction

A new homomorphic modular reduction method in the disclosure may use MSB bootstrapping (of large-scale precision) as a subroutine.

In the case where slot-encoding RLWE ciphertext

$$ct = ( b , a ) ∈ {ℛ}_{q}^{2}$$

encodes message \vec{z}∈ [symbol] ^{N/2}, the processor 120 may select base-level scaling factor Δ₀ as Δ₀=q₀. The processor 120 may perform StC and [⋅]_{q0} to obtain a coefficient-encoding RLWE ciphertext that encodes plaintext [z(X)]_{q0}∈ [symbol] . Herein, the coefficient may be adopted from [Re(Z))₁ or [Im (Z)]₁. The processor 120 may apply MSB bootstrapping to restore modulus, and obtain desired modulus reduction. This method may be operable in both of the discrete data and approximate data.

### Contribution

### Efficient MSB Bootstrapping for Reals

In the case of an existing CKKS bootstrapping method, a certain amount of gap is required between base modulus and a message to homomorphically approximate a modular reduction function, and in this case, bootstrapping instances may cause additional modulus consumption in the bootstrapping process as well as failure in supporting the modular reduction. In particular, as the size of a message increases through the process of ModRaise (e.g., from m to m+q₀I), greater module tends to be used for each bootstrapping (e.g., [Cry22]), and considering that modulus is a very restricted resource in homomorphic encryption, deterioration in performance may be caused.

In other words, it is important to find efficient MSB bootstrapping (additionally, necessary for a modulus reduction framework), but conventionally, most significant bit (MSB) bootstrapping is dealt with partially in [BGJ20], but an existing definition of bootstrapping is not encompassed properly.

In the disclosure, MSB bootstrapping may be generalized. First, the biggest obstacle of discrete bootstrapping of [BKSS24] is that complexity in calculation increases exponentially as bit precision increases. To solve the problem, an iterative method like [BCC+22, BZP+23] may be adopted to support high-precision discrete bootstrapping efficiently in the disclosure. Additionally, the processor 120 may expand (raise) modulus up to MSB bootstrapping with respect to a real number through a modulus switching step at the lowest modulus. By doing so, according to the disclosure, a complete MSB bootstrapping framework may be provided.

### Asymptotically Faster Homomorphic Modular Reduction

All existing approaches [CHK+18, LLL+21, JM22, LLK+22, HMWW24] depend on polynomial approximation in homomorphic modular reduction using CKKS. In other words, to approximate Mod₁ function over section [−k, k], a degree of an approximation polynomial may be approximately proportional to k. To see this, the root of a polynomial (the number of integer points) with k as a degree is counted, and the number is 2k+1. In this context, homomorphic modular reduction in a wide section may require a great amount of computation, and in some cases, may be impossible.

Regarding this, the modular reduction method of the disclosure may be independent from an input section [−k, k]. For example, the processor 120 may use an original modular reduction function itself independent from the input section, rather than approximating a modular reduction function in an existing wide section [−k, k]. By doing so, modular reduction may be provided very efficiently in a wide section in the disclosure.

Better Discrete Function Evaluation from Discretization

Modulus conversion at the lowest modulus may enable discretization of a coefficient-coding CKKS ciphertext to a coefficient-coding discrete CKKS ciphertext. By doing so, the processor 120 discretize an ordinary CKKS ciphertext, and then use a discrete-CKKS method. The discrete CKKS may support any function evaluation based on a look-up table like [CKKL24] and this may be an advantage deemed to be more importance than that of existing CKKS. Additionally, the processor 120 may bit-decompose a CKKS ciphertext with a framework of [BKSS24], and this may provide an alternative solution with respect to a comparison-like function.

A look-up table-based approach enables a rapid evaluation of many functions that are hardly approximated. For example, an exponential function as a non-polynomial function, a reciprocal, a square root, ReLU and the like may be evaluated in this way. Such functions may be necessary for machine learning that is one of the fields in which homomorphic encryption is used mainly. Additionally, the method may be deemed as a similar thing of quantization, and produce the effect of lowering calculation costs by reducing a base data type of a message.

A bit-decomposed CKKS ciphertext may be used to accelerate a comparable similar function such as argmax and sorting. Since an existing homomorphic comparison approach uses polynomial approximation, big multiplication depth and time are required for an evaluation, and a function including homomorphic comparison as a subroutine may be very expensive. On the contrary, comparison of bit-decomposed ciphertexts may be relatively inexpensive, and based on the comparison, a more complex function such as argmax and sorting may be established.

### Concrete Experiments

The subject matter of the disclosure may be implemented based on a C++ HEaaN library [Cry22]. All experiments were conducted at a single thread CPU and are implementable as surplus number degree N=2¹⁶. FIG. 4 is a view illustrating a summary of performance of iterative MSB bootstrapping and homomorphic modular reduction with respect to integers and real numbers according to one embodiment. In FIG. 4, high-precision iterative MSB bootstrapping (respectively homomorphic modular reduction) using an input/output of 15 bits is expressed as IntBoot (respectively IntMod), and iterative MSB bootstrapping (respectively homomorphic modular reduction) using a real-number input is expressed as Boot (respectively Mod).

Additionally, a new bit decomposition method using a framework of the disclosure was compared with a method suggested by Drucker et al. [DMPS24]. According to the disclosure, 10-bit decomposition that is 7.1 times faster than the method suggested by Drucker et al. [DMPS24] may be secured while precision is maintained.

### Related Works

### Discrete CKKS

The message space of an existing CKKS [CKKS17] is [symbol] ^{N/2}, and the message space may be described as approximate data. [DMPS24] may adopt embedding to [symbol] ^{N/2} and use a discrete message space. For example, {0,1} bit may be embedded into [symbol] ^{N/2} based on identity embedding. One of the main differences between approximate CKKS and discrete CKKS is that the discrete CKKS has a “cleaning” concept of removing noise of a base plaintext. To improve the efficiency of embedding, [CKKL24] adopted root-of-unity embedding and explored multivariate interpolation.

### Modular Reduction

Research into modular reduction as one of the main steps of CKKS bootstrapping called EvaMod was widely conducted throughout CKKS documents [CHK18, LLL21, JM22, LLK22], but could be evaluated only with respect to a small range (e.g., 25 cycles) due to a limitation (see [HMWW24]) of polynomial approximation. Regarding this, according to the disclosure, an inherent modular reduction function inherent in RLWE may be used. In studies [KDE24, CCKS23], such a function was used to establish a partial function in a CKKS scheme, but modular reduction was not integrated into the main computation of CKKS. One of the essential technologies for enabling efficient modular reduction may be most significant bit (MSB) bootstrapping, and may enable bootstrapping a ciphertext having no gap with modulus. Existing MSB bootstrapping [BCKS24, BGGJ20, BKSS24] does not provide efficient bootstrapping with respect to real numbers that can allow modular reduction. In the disclosure, to solve the problem, iterative bootstrapping (see [BCC+22, BZP+23]) was used, while modulus conversion was used properly.

### Preliminaries

In the case of [symbol] = [symbol] [X]/(X^{N}+1) and [symbol] _{Q}= [symbol] /Q [symbol] with respect to Q∈ [symbol] _{>0} when N is integers that are powers of 2, [m]_{q} may be modular reduction of which an output value belongs to (−q/2, q/2] and has a symbol (sign) with respect to m∈ [symbol] .

### CKKS Basics

When secret key sk∈ [symbol] is given in the case where m∈ [symbol] is a plaintext, RLWE ciphertext ct encoding m may satisfy [ct·sk]_{Q}=m in a pair of

$$( b , a ) ∈ {ℛ}_{Q}^{2} .$$

### Encoding Structure

In the case where m(x)∈ [symbol] is a plaintext, while Δ∈ [symbol] is a scaling factor, DFT: R[X]/(X^{N}+1)→ [symbol] ^{N/2} may be defined as follows.

$$DFT ( p ( x ) ) = {( p ( {ζ}_{i} ) )}_{0 \leq i < N / 2}$$

Herein, ξ₁=ξ⁵^{¹} relates to 2N-degree root-of-unity ξ, and decryption map Dcd: [symbol] →C^{N/2} may be defined as follows.

$$Dcd ( m ) = \frac{1}{Δ} DFT ( m )$$

In the case where iDFT: [symbol] ^{N/2}→ [symbol] [X]/(X^{N}+|1) is a reciprocal of DFT, encoding map Ecd: [symbol] → [symbol] ^{N/2} may be defined as follows

$$Ecd ( Z ) = ⌊ Δ \cdot iDFT ( Z ) ⌉$$

Encoding and decoding may provide a response between R and [symbol] ^{N/2}, and by doing so, [symbol] ^{N/2} may be used as a message space of the RLWE ciphertext.

### Rescaling

In the case where

$$ct = ( b , a ) ∈ {ℛ}_{q}^{2}$$

is a CKKS ciphertext encoding \vec{z}∈ [symbol] ^{N/2} by using scaling factor Δ, rescaling ct to q|Q may be defined as follows.

$$RS ( ct ) = ( \frac{b - {[ b ]}_{q}}{q} , \frac{a - {[ a ]}_{q}}{q} )$$

This may reduce the scaling factor from Δ to Δ/q.

### CKKS Bootstrapping

Modulus of the CKKS ciphertext may be decreased while going through homomorphic computation. To restore the modulus, the processor 120 may perform bootstrapping of increasing the modulus while preserving a base message in an approximate manner. Existing CKKS bootstrapping [CHK+18] is operated as follows.
1. Slot-coefficient conversion (Slots-to-Coefficients, StC): DFT may be evaluated to covert a ciphertext encoding message \vec{z} homomorphically to a ciphertext encoding plaintext z(x) of which coefficients are slots of \vec{z}.
2. Modulus raising (ModRaise): in the case where coefficient-encoded ciphertext

$$ct ∈ {ℛ}_{q 0}^{2}$$

encoding plaintext m(x)∈ [symbol] in lower-end module q₀ is given, this may be embedded into [symbol] with respect to greater Q, in other words, this may be embedded into [symbol] ² based on embedding of [symbol] ₜ→ [symbol] and modulo Q may be adopted. From the perspective of plaintext m, this involves changing m to m+q₀I of, and herein, I may be a small-integer polynomial of R.
3. Coefficient-slot conversion (Coefficients-to-Slots, CtS): iDFT may be evaluated homomorphically to convert a ciphertext encoding plaintext m(x) to a ciphertext encoding message \vec{m} Herein, \vec{m} may be a coefficient of m(x).
4. Approximate Modular Reduction (EvalMod): To remove a small multiple of q₀ introduced during ModRaise, a modular reduction function may be approximated and evaluated. Ordinarily, using a polynomial approximating partial trigonometric functions may be selected. Since continuity of approximate modular reduction is required, a gap may be required between message m and base modulus q₀ during ModRaise.

### Discrete Computations in CKKS

### Discrete Encoding

In [DMPS24], an integer vector was regarded as a complex number vector to calculate discrete data, and ordinary CCKS encoding was used to encode integers directly. The advantage of such encoding is that arithmetic computation such as addition and multiplication may be naturally inherited from the attribute of homomorphism of CCKS.

Another type of encoding as root-of-unity encoding suggested by [CKKL24] may concentrate on a primitive t-th root of unity with respect to certain t, and see. [symbol] ₜ as the idea of x [symbol] e^{2π2x/t}: [symbol] t→ [symbol] As described in [CKKL24], the root-of-unity provides a numerically reliable look-up table evaluation, and this may mean that a precise evaluation is provided with respect to any function φ:{1, ω, . . . , ω^{t-1}}→ [symbol] . Herein, ω=e^{2π2/t} may be a primitive t-th root of unity, and hereafter, a homomorphic evaluation of φ is expressed as LUT_{φ}.

### Discrete Bootstrapping

In [BCKS24], CCKS bootstrapping is applied in accordance with bit encoding {0,1}, and bootstrapping is enabled with no gap between a message and base modulus, to reduce modulus consumption. To this end, CCKS modified ModRaise and EvalMod.
ModRaise: Δ=q₀/2 is set such that a bit is disposed at the most significant bit of ciphertext

$$ct ∈ {ℛ}_{q 0}^{2} .$$

EvalMod: An approximate modular reduction function is replaced with trigometric function

$$f ( x ) = \frac{1}{2} ( 1 - cos ( 2 π x ) )$$

to obtain. f(b/2+I)=b. Herein, b∈{0, 1}, I∈ [symbol] .

This refer to such new bootstrapping as BinBoot, and BinBoot may include not only bootstrapping a bit rightly but also partial cleaning [BCKS24, Theorem 1].

In [BGGJ20], yet another bootstrapping of CCKS using complex exponential x [symbol] e^{2πix} is described in the process where conversion from CGGI to CCKS is described (Section 4.1). At a time when an integer coefficient-encoded CCKS ciphertext is limited to a lower level, bootstrapping thereof may be interpreted as bootstrapping from an integer encoding state to a root-of-unity encoding state.

For example,

$$f ( x ) = \frac{1}{2} ( 1 - cos ( 2 π ) )$$

may be a ciphertext encoding the most significant bit of plaintext mER together with a scaling factor of size q/t. This may be regarded as encoding. (q/t)m+qI (a certain small I∈R), and herein, ct may be deemed to be a ciphertext of [symbol] ²(=ModRaise). Then the scaling factor is set as q, and complex exponential x [symbol] ^{e2πix} may be evaluated homomorphically. This may involve mapping m/t+I as, e^{2πxm/t} and essentially, may involve converting integer encoding into root-of-identity encoding.

### Bootstrapping the Most Significant Bits

In the case of existing bootstrapping, a gap may be required between a message and base modulus to approximate modular reduction. Hereafter, an existing (discrete) bootstrapping method requiring no gap and an iterative bootstrapping algorithm of improving precision efficiently are described. Additionally, a method of bootstrapping real numbers at the most significant bit is described hereafter.

### Revisiting the Existing Discrete Bootstrapping Methods

First, an existing bootstrapping method for discrete data calculation is described again. For example, integers are combined with root bootstrapping of [BGGJ20], and a framework of [CKKL24] is used to perform an evaluation of an integer-root look-up table, thereby configuring efficient integer-to-integer bootstrapping at the most significant bit. This structure may also be deemed to be generalization of BinBoot of [BCKS24]. The bootstrapping may be outlined as follows.
0. Parameter Setting: Input and output ciphertexts both encode an integer-encoding message in a slot-encoding state. Each integer of the message belongs to (−t/2, t/2] to avoid an overflow. The lowest-level scaling factor is set to Δ₀=q₀/t, such that the message is encoded at the most significant bit. ψ: [symbol] ₜ=(−t/2, t/2┘→ [symbol] ^{N/2} is defined as ψ(x)=e^{2πix/t}, and this is an idea relating to root-of-identify encoding.
1. Slots-to-Coefficients: Put a slot into a coefficient.
2. Modulus-Raising: Increase modulus like existing CCKS bootstrapping.
3. Coefficients-to-Slots: Put the coefficient to the slot again.
4. Homomorphic Exponential: Complex exponential x [symbol] e^{2πix} is evaluated homomorphically, and like [BGGJ20], an integer is sent to a root of unity. This process is referred to as EvalExp.
5. Homomorphic ψ⁻¹: To restore the integer from the root of unity to an integer again, a reciprocal of ψ is evaluated homomorphically. This process may be referred to as LUT_{ψ}_{^{−1}}.

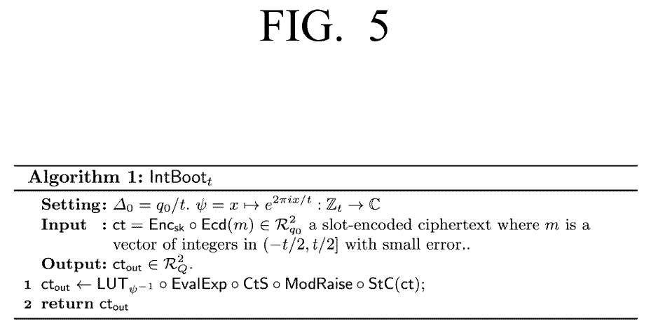

Hereafter, such bootstrapping is referred to as IntBootₜ, and this is described in detail with reference to algorithm 1 of FIG. 5. The accuracy of the bootstrapping may be directly seen based on the elements thereof EvalExp and. LUT_{ψ}_{^{−1}}, and this is independently verified in [BGGJ20] and [CKKL24] respectively. As a method corresponding to HalfBoot of [CHK+21]. IntBootₜ without a first step StC is described as. HalfIntBootₜ, hereafter.

### Remarks on the Instantiation

The implementation of StC, ModRaise, CtS, and. LUT_{ψ}_{^{−1}} may be simple, and a latest method may be used with respect to each computation. On the contrary, in relation to the implementation of EvalExp, a tailor expansion of complex exponential x [symbol] e^{2πix} from 0 is used in [BGGJ20], and this is certainly operable but is not numerically reliable and cause deterioration in efficiency.

### Iterative Bootstrapping

The processor 120 may perform iterative bootstrapping based on IntBootₜ.

For example, the processor 120 may extract the least significant figure by using

IntBootₜ, and repeat the extraction [symbol] times, to obtain boorstrapping with respect to a plaintext space of size. [symbol] . Entire bootstrapping is referred to as

$${IntBoot}_{t}^{ℓ} ,$$

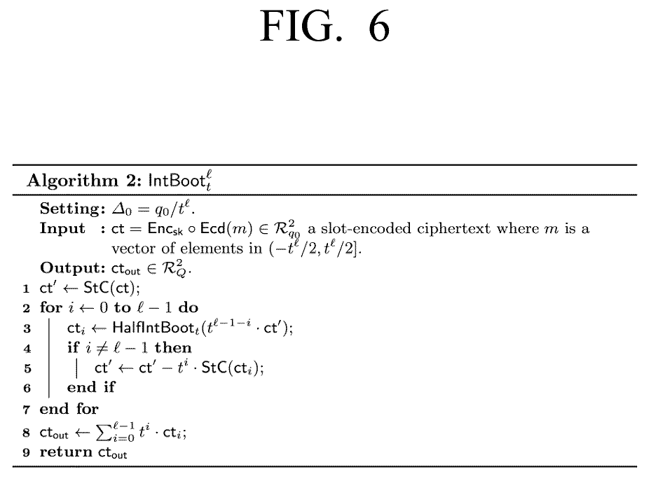

and a detailed algorithm is the same as algorithm 2 of FIG. 6.

The processor 120 may start with sufficiently precise StC and dispose a message from a slot to a coefficient at (− [symbol] /2, t [symbol] /2). Multiplication by [symbol] may be extracting the least significant figure. Accordingly, the processor 120 may use HalfintBootₜ as a subroutine, and output a slot-encoded ciphertext encoding the least significant figure. The processor 120 may perform StC, and deduct StC from a coefficient-encoded original ciphertext, to obtain ciphertext (t [symbol] → [symbol] ) having a one-digit less figure. The processor 120 may extract all figures and repeat the extraction until the figures are stored in upper modulus. The processor 120 may combine all the figures in a linear combination, to restore an entire message. Since

$${IntBoot}_{t}^{ℓ}$$

requires [symbol] times of HalfintBootₜ and [symbol] times of StC, costs may be incurred as much as the costs of [symbol] times of IntBootₜ,

### Extensions

### Bootstrapping Real Numbers

The processor 120 may generalize IntBoot and configure bootstrapping with respect to real numbers.

$${ModSwitch}_{q}^{{q}^{′}} : {ℛ}_{q} \to {R}_{{q}^{′}}$$

is defined as modulus conversion, and this is conversion from q to q′, and if necessary, may be expanded to

$${ℛ}_{q}^{k} \to {R}_{{q}^{′}}^{k}$$

with respect to k≥1. For example, the processor 120 may set the modulus conversion as [symbol] and discretize a real-number message to a discrete message.

In the case where

$$ct = {Enc}_{zk} ( ( q / t ) m ) ∈ {ℛ}_{q}^{2}$$

is a slot-encoded CCKS ciphertext which encodes plaintext m and of which a slot is (−1/2, 1/2], the processor 12 may set the lowest-level scaling factor to Δ₀=q₀ after StC such that m is in a coefficient of the most significant bit. The processor 120 may modulus-switch the ciphertext to [symbol] with respect to t, [symbol] ≥1 selected properly, and modulus-switch [symbol] to q₀² again, such that the . . . is compatible with

$${HalfIntBoot}_{t}^{ℓ} .$$

The processor 120 may apply

$${HalfIntBoot}_{t}^{ℓ}$$

to complete our bootstrapping. Since the modulus switching is an identity function fundamentally, the modulus switching may provide bootstrapping having precision of about [symbol] with respect to ct. Hereafter, such bootstrapping is expressed as

$${Boot}_{t}^{ℓ}$$

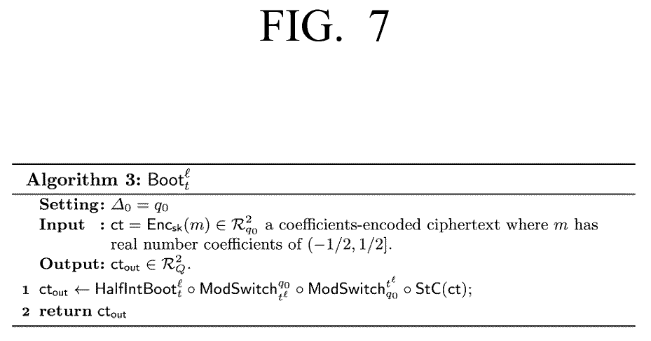

and a detailed algorithm is suggested in algorithm 3 of FIG. 7.

$${Boot}_{t}^{ℓ} ,$$

may be operated up to modulo 1. In other words, −1/2 is deemed to be the same as 1/2, and a message close to −1/2 may be bootstrapped to be close to 1/2, or vice versa. At a time of configuring homomorphic modular reduction and bit decomposition, bootstrapping with respect to modulo 1 is enough. If accurate bootstrapping ensuring accuracy without the condition of “up to modulo 1” is required, an error may be restored based on deduction and bootstrapping, such that this is processed.

### Bit Extraction

Referring back to algorithms 2 and 3 to find different versions of

$$ct ∈ {ℛ}_{{q}_{0}}^{2}$$

one additional bit extraction step may be added with respect to each ct_{1 (}0≤i< [symbol] ).

First, the way of extracting a bit from roots of unity may be defined as extracting lⱼ: {1, ω, . . . , ω^{t-1}}→{0, 1} from a j^{th} lowest bit from of a coefficient. Herein, this may be 0≤j<t.

Evaluating LUTᵢⱼ with respect to each j may provide all bits of the roots of unity.

If LUTᵢ is defined as executing. LUTᵢⱼ on all js and outputting t numbers of ciphertexts encoding bits of an initial ciphertext respectively, the processor 120 may replace LUT_{ψ}_{^{−1}} of algorithm 1 with the LUTₜ, and obtain a bit extraction version of IntBootₜ, and this may be naturally expanded to

$${IntBoot}_{t}^{ℓ} and {Boot}_{t}^{ℓ} .$$

A bit extraction of a ciphertext may be useful at a time when discrete functions are calculated, and in particular, may be useful in the case where complex discrete functions need to be comprised of simpler discrete functions as a subroutine.

Bit decomposition with respect to a CKKS ciphertext is already suggested in [DMPS24, Algorithm 3]. If t is fixed, while our parameter [symbol] is deemed as an analogue of N in their algorithms, their algorithms may be described as iterating a homomorphic sign function of O( [symbol] ) bit precision O( [symbol] ) times. According to [CKK20, Theorem 1], the sign function of O( [symbol] ) bit precision consumes an O( [symbol] ) multiplication depth at an optimal depth. On the contrary, depth consumption of IntBootₜ is irrelevant to [symbol] . Accordingly, an algorithm of the disclosure may be described as evaluating circuitry of depth O(1) [symbol] times, and may be much better than this asymptotically.

### Discretization

Modular reduction of CKKS ciphertexts encoded with a coefficient may provide modular reduction with respect to base plaintexts thereof. In the case where the modular reduction is applied, the processor 120 may use the above-described bootstrapping method to restore modulus. Hereafter, q₀ as base modulus, Q bootstrapping output modulus, and q as any CKKS modulus between q₀ and Q are described as becoming q₀ or Q for convenience.

### Homomorphic Modular Reduction

For simplification, in the case where a modulo 1 function for CKKS (with a symbol (sign)) is suggested, reduction caused by any modulo (modular) may be readily configured with proper constant multiplication.

Based on homomorphic modular reduction of the disclosure, [⋅]q₀ may be readily performed with respect to a ciphertext of any CKKS modular. For example, at a time when message m∈ [symbol] _{q} is encrypted,

$${[ ct ]}_{qo} ∈ {ℛ}_{qo}^{2}$$

may encrypt message

$${[ m ]}_{qo} ∈ {ℛ}_{qo}^{2}$$

with respect to

$$ct ∈ {ℛ}_{q}^{2} .$$

Additionally, based on homomorphic modular reduction of the disclosure, [⋅]_{q0} may be approximately used as a proper scaling factor to calculate [⋅]₁. For example,

$$[ z ] 1 = \frac{1}{q 0} \cdot {[ {q}_{0} \cdot z ]}_{q 0} + ϵ \vert$$

may be with respect to z∈ [symbol] , and herein, this may be

$$‖ ϵ ‖ \leq \frac{1}{{\sqrt{Z}}_{q 0} .}$$

In other words, since . . . may be expanded to/with any modulo (modular), any modular reduction using. [⋅]_{q0} may be possible.

$$ct ∈ {ℛ}_{q}^{2}$$

may be a slot-encoded CKKS ciphertext at modules q. \vec{z}∈ [symbol] ^{N/2} may be encrypted, and StC may be set as q₀ in OG as a scaling factor after StC. The processor 120 may limit modulus of ct to perform StC, and then perform StC with following scaling factor Δ_{StC}. In this case, output ciphertext ct′ may be a ciphertext at modulus q₀, and the ciphertext may encode q₀. \vec{z} in a coefficient. That is, in the case where [⋅]_{q0} is performed with respect to ct′, a ciphertext of based modulus may be obtained, and may be a result of encoding [\vec{Z}]₁ at the most significant bit (MSB). The processor 120 raise modulus from q₀ to Q by using

$${HalfBoot}_{t}^{ℓ}$$

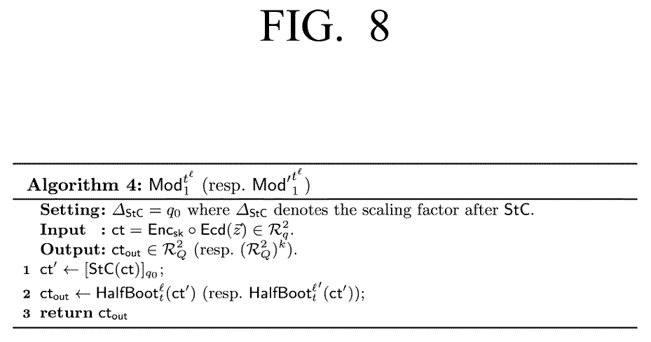

to maintain a main bit. Detailed description in relation to this is provided with reference to algorithm 4 of FIG. 8.

A number of studies [CHK+18, LLL+21, JM22, LLK+22] of modular conversion function computation of base modulus have already been performed homomorphically. The modular conversion function computation is an essential subroutine in CKKS bootstrapping, but existing methods may not be used as a ciphertext modular reduction function since this is operated in a limited section. In greater detail, existing bootstrapping methods perform modular reduction by using a polynomial approximate sign function with respect to continuous data, and are only appropriate for approximation near a small integer. Additionally, a LUT size caused by a difference between a message size and base modulus is inefficient.

On the contrary, in the homomorphic modular reduction method of the disclosure, data may be discretized based on modulus switching first, and then calculated with a root-of-unity encoding-based LUT. In other words, the LUT may match a modular reduction function in an entire section uniformly distributed with respect to a discrete input, and accordingly, the modular reduction in the entire section may be performed homomorphically with high precision and efficiency, thereby avoiding a waste of memory.

One of the direct and important applications may be homomorphic rounding. Deducting an output of

$${Mod}_{1}^{{t}^{ℓ}}$$

from an original ciphertext may correspond to a homomorphic floor function. In the case where normalization is used, a homomorphic rounding function may also be obtained. The homomorphic rounding may be simple but an important step function, and based on proper normalization, may be expanded to more step functions such as a sign function and the like. A previous step function calculation method [HMWW24] involves performing approximation by using a massive-scale polynomial, causing a problem such as inefficiency in the case of a wide input range, and a growing number of computation steps. Unlike a previous method, the homomorphic rounding of the disclosure is advantageous in that computation complexity may be irrelevant to an input range, and that the homomorphic rounding may be performed at the same time as bootstrapping is performed in the way that the homomorphic rounding is hidden during the bootstrapping. In other words, the homomorphic rounding and the bootstrapping may be processed at the same time.

As an integer adaptive version of

$${Mod}_{1}^{{t}^{ℓ}} ,$$

IntModₜ_{^{e}} using

$${HalfIntBoot}_{t}^{ℓ}$$

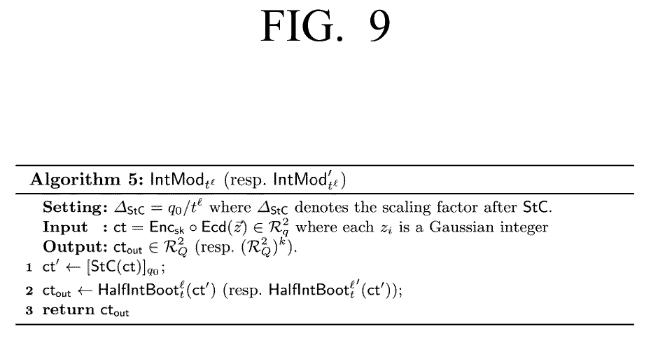

to adopt modulo [symbol] may be defined with respect to Gaussian integers, and detailed descriptions in relation to this are provided with reference to algorithm 5 of FIG. 9. HalfIntBoot may be slightly modified to respectively perform HaifintBootₜ_{ₜ} once with respect to i=1, . . . , [symbol] rather than performing HalfIntBootₜ [symbol] times, and defined as. IntMod₍ₜ_{ₜ}₎_{_{tm1, . . . x}} adopting a modulo of a Gaussian integer with respect to modulus. t₁ . . . [symbol] . This may be useful when integer modular reduction is calculated with respect to modulus having a large number of prime factors. Additionally, there may be

$${Mod}_{1}^{′ {t}^{ℓ}} and {IntMod}_{{t}^{ℓ}}^{′}$$

that are bit decomposition versions respectively in

$${Mod}_{1}^{{t}^{ℓ}} and {IntMod}_{{t}^{ℓ}} .$$

Bootstrapping using Modular Reduction

The bootstrapping method in the case where a message is at the most significant bit may enable bootstrapping after integers or real numbers are placed at the most significant bit properly based on multiplication of base modulus by a constant. Hereafter, a bootstrapping method of integrating bootstrapping into a homomorphic modular reduction framework, and bootstrapping an ordinary CKKS ciphertext having fixed parameters

$${Mod}_{1}^{{t}^{ℓ}} and {IntMod}_{{t}^{ℓ}} .$$

The processor 120 may use

$${Mod}_{1}^{{t}^{ℓ}}$$

to perform modular reduction of a decimal portion, regard the remaining portions as big integers, and use [symbol] to repeat bootstrapping. The bootstrapping is expressed as

$${Boot}_{{t}^{ℓ}}^{k} ,$$

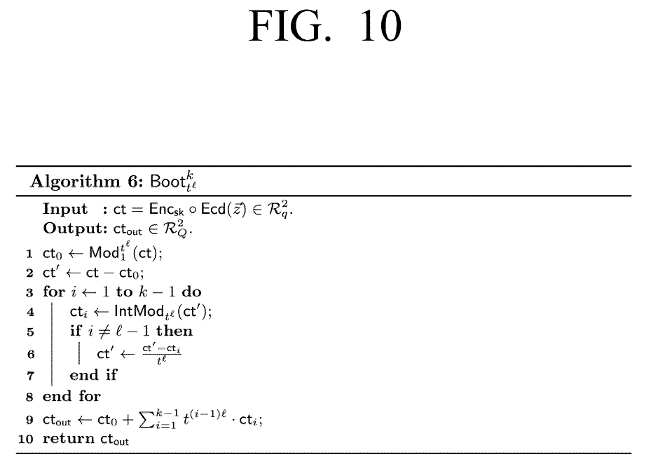

and a detailed algorithm is illustrated in algorithm 6 of FIG. 10. A CKKS ciphertext of which the decimal portion is [symbol] log t bit, and the integer portions are (k−1) [symbol] log t is only described, but proper normalization for adjusting the sizes of the decimal portion and the integer portions may be possible.

Additionally, a bit-decomposition analogue of

$${Boot}_{{t}^{ℓ}}^{k}$$

outputting all k [symbol] log t bits rather than the entire ciphertext may also be possible. An output of this sort may be useful to evaluate a discrete function, and this is because using a bit is often more efficient than using am approximate value with respect to an ordinary real number.

$${Boot}_{{t}^{ℓ}}^{k}$$

may require one

$${Mod}_{1}^{{t}^{ℓ}}$$

and k−1 numbers of [symbol] , and each algorithm may require one StC and one

$${HalfIntBoot}_{t}^{ℓ} .$$

### Since

$${Boot}_{{t}^{ℓ}}^{k}$$

requires k numbers of

$${HalfIntBoot}_{t}^{ℓ} .$$

and k numbers of StC, costs may be incurred by k numbers of

$${IntBoot}_{t}^{ℓ}$$

or k [symbol] umbers of IntBootₜ.

### Applications

Modulo Small Integer Arithmetic with CKKS

In the case where efficient homomorphic modular reduction

$${Mod}_{1}^{k}$$

is used, modulo m computation with respect to m∈ [symbol] _{>0} may be naturally configured in CKKS. In CKKS, [symbol] ₘ computation is configured in [DMPS24, Section 8.1], and since this depends on expensive bit decomposition, this is extremely inefficient, but according to the disclosure, natural modular reduction of a RLWE ciphertext may be used, thereby incurring costs of a maximum k numbers of BinBoot with respect to precision parameter k.

It may be meant that modular reduction using a strategy different from that of [DMPS24] with respect to [symbol] ₘ computation is more preferable than the modular reduction lazily performed according to the disclosure. Costs of homomorphic modular reduction suggested in [DMPS24] may vary depending on the size of input data, but the algorithm of the disclosure may not be the case.

### Discrete Functions

The framework of the disclosure may provide a method of discretizing a message. In other words, with respect to a given CKKS ciphertext encoding real numbers, a ciphertext encoding integers or bits may be output. This may be helpful to better evaluate a discrete function deemed as a main problem in CKKS.

For example, the framework of the disclosure may provide bit decomposition of a CKKS ciphertext, and establish a discrete function such as comparison, a maximum value, sorting more efficiently.

Unlike a previous approach, the subject matter of the disclosure is advantageous in outputting only a result discretized all the time without an intermediate value. In the case where a polynomial approximate value is used, a polynomial may not avoid the occurrence of an intermediate output on a boundary case since the polynomial is continuous, but the subject matter of the disclosure depends on converting into discontinuous modulus. 24, thereby making it possible to discretizing any real number completely.

### Quantization

1. Approximate CKKS→Discrete CKKS
2. Analogue of the quantization in Machine Learning

### Experiments

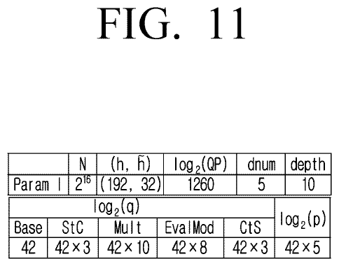

The subject matter of the disclosure was developed on a C++ HEaaN library, and all the experiments and measurement were performed at single thread CPU, 512 GB RAM, 2.8 GHZ Intel Xeon Gold 6242 using Ubuntu 20.04.5 LTS as an operating system. For the experiments, a new parameter having 128-bit security was configured, and average precision and worst precision with respect to e∈ [symbol] ^{N/2} that is a difference between the message of an output ciphertext and the message of an input ciphertext were measured. The average precision and the worst precision may be −log₂ [symbol] (∥e∥₁) and −log₂ max∥e∥_{∞} respectively. Additionally, average execution time according to the disclosure was measured. All the experiments were performed repeatedly 100 times or greater. T_{avg}, Pₘ and P_{w} may indicate the average execution time, the average precision, and the worst precision respectively, and are illustrated in FIG. 11.

### Iterative Bootstrapping

According to the disclosure, repetitive bootstrapping was implemented based on IntBootₜ of which t equals 32, and repetitive times [symbol] may vary from 1 to 4 to measure the average and worst precision and the execution time. The processor 120 may bootstrap normalized integers rather than integers. For example,

$${IntBoot}_{t}^{ℓ}$$

may bootstrap a ciphertext encoding a vector that is {n/ [symbol] |n∈[0, [symbol] ∩ [symbol] }^{N/2}. Accordingly, precision may mean the number of bits preserved from the most significant bit (MSB) of an input message.

Additionally, according to the disclosure, repetitive bootstrapping of a normalized version with respect to real numbers was implemented as

$${Boot}_{t}^{ℓ} .$$

This may maintain the above-described settings without changing the settings by using

$${halfIntBoot}_{t}^{ℓ}$$

as a subroutine.

$${Boot}_{t}^{ℓ}$$

may bootstrap a ciphertext encoding vector \vec{e} that is \vec{e}∈[0, 1)^{N/2}. Since

$${Boot}_{t}^{ℓ}$$

is operated as (with) modulo 1, as modulo 1 error may be measured in the case.

Precision of repetitive bootstrapping may not depend on [symbol] and may be actually sufficiently high. However, precision of repetitive real-number bootstrapping increases as [symbol] increases, and may differ from that of the repetitive bootstrapping. In the disclosure, since an input ciphertext is discretized based on modulus switching before halfIntBoot, the subject matter of the disclosure may be reasonable, and precision may not be greater than log [symbol] . In other words, the size of an error may be increased because of discretization at a time of multiplication of a secret key in decryption, and the precision of the repetitive real-number bootstrapping may be slightly less than log [symbol] . Execution time of both

$$Int {Boot}_{t}^{ℓ} and {Boot}_{t}^{ℓ}$$

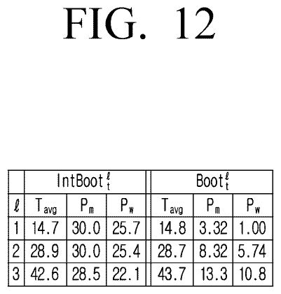

may be [symbol] times greater than IntBootₜ and Bootₜ since halfIntBootₜ in the algorithms is performed [symbol] times, but measurement time may be slightly less than expected since StC is performed only once regardless of [symbol] , and a result thereof is illustrated in FIG. 12.

### Modular Reduction

According to the disclosure, modular reduction and bootstrapping may be performed together at the same time. For example, in the case where an input ciphertext encodes a message

$$\vec{z} ∈ {ℂ}^{N / 2} , {Mod}_{1}^{{t}^{ℓ}}$$

may output a ciphertext encoding [\vec{z}+\vec{e}]₁∈ [symbol] ^{N/2} together with greater modulus. Average and worst precision may be defined as usual by using error \vec{e}∈ [symbol] ^{N/2}, and unlike that of an existing one, the precision may vary depending on the size of an integer portion of an input vector. In other words, according to the disclosure, bit length of the size of the input vector is expressed as log₂[z], and the bit length may be changed in various ways, and

$$halfInt {Boot}_{t}^{ℓ}$$

was used as a subroutine, to implement IntModₜ_{^{e}} that is an integer version of

$${Mod}_{1}^{{t}^{ℓ}} .$$

### Additionally,

$${Boot}_{{t}^{ℓ}}^{h}$$

as a real-number bootstrapping method using

$${Mod}_{1}^{{t}^{ℓ}}$$

and IntModₜ_{^{e}} was implemented, and a result based on

$${Mod}_{1}^{{t}^{ℓ}}$$

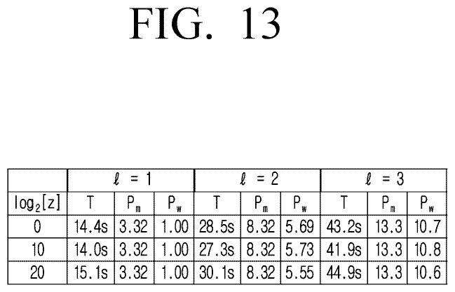

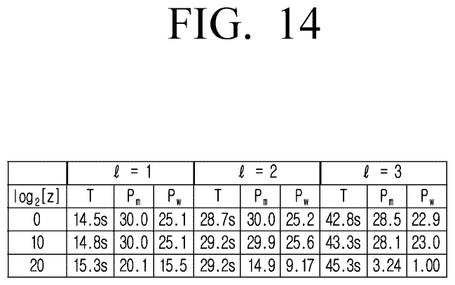

is illustrated in FIG. 13, a result based on IntModₜ_{^{e}} is illustrated in FIG. 14, and a result based on

$${Boot}_{{t}^{ℓ}}^{k}$$

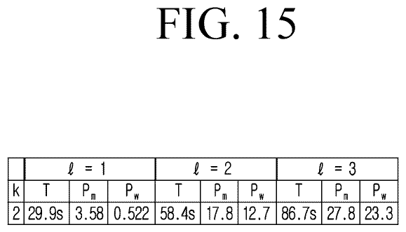

is illustrated in FIG. 15.

### Bit Decomposition

A bit decomposition method using a frame work of the disclosure is compared with a latest bit decomposition method using an approximate sign function as a subroutine, suggested in [DMPS24].

In the case of k-bit decomposition, both the two methods may receive a ciphertext ct encoding message \vec{z}∈[0,1)^{N/2} as an input. Additionally, in these methods, a ciphertext vector of (ctᵢ)_{0≤i<k} is output, and herein, ctᵢ may encode i^{th} bit vector \vec{bᵢ} of \vec{z} with respect to each slot.

Two types of errors may be used to compare the two methods. A first error may indicate how close is an output message to 0 or 1. The first error is defined as

$${P}_{w}^{1} = - {log}_{2} max {‖ \vec{{e}_{1 , i}} ‖}_{∞} and {P}_{m}^{1} = - {log}_{2} 𝔼 ( {‖ \vec{{e}_{1 , i}} ‖}_{1} ) ,$$

and herein, . . . may be

$$\vec{{e}_{1 , i}} = \vec{{b}_{i}} - ⌊ \vec{{b}_{i}} ⌉ , ( 0 \leq i < k ) .$$

In relation to this, failure probability p_{fail} may be defined as (with) an elemental ratio of vector

$$\vec{{e}_{1 , i}}$$

exceeding 2^{-k}. The definition may be natural since error 2^{-k} affects the extraction of a k^{th} bit at the MSB, causing inaccurate decomposition. A second error may indicate how accurately bit decomposition is performed. As

$$\vec{{e}_{2}} = \vec{z} - {\sum }_{0 \leq i < k} \frac{⌊ \vec{{b}_{i}} ⌉}{{2}^{e + 1}} , {P}_{w}^{2} = - {log}_{2} max {‖ \vec{{e}_{2}} ‖}_{∞} and {P}_{m}^{2} = - {log}_{2} 𝔼 ( {‖ \vec{{e}_{1}} ‖}_{1} )$$

are defined, a result of a rounded output vector was used to calculate the second error, such that the first type of error may be ignored at a time of calculation of the second error.

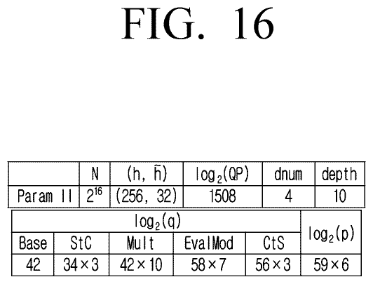

Further, 10-bit decomposition was used to compare the two methods, and in implementing the bit decomposition method explained by Drucker et al. ([DMPS24]), a parameter having an identical RLWE degree and identical multiplication depth was used to secure fair comparison. Details of the parameter are provided in FIG. 16. A homomorphic sign function suggested by Cheon et al. ([CKK20]) was used, and in detail, an approximate sign function obtained by synthesizing seventh-degree polynomial

$${f}_{3} ( x ) = - \frac{5}{16} {x}^{7} + \frac{21}{16} {x}^{5} - \frac{35}{16} {x}^{3} + \frac{35}{16} x$$

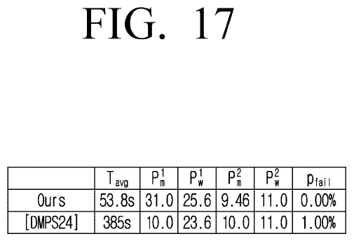

six times was used, and a result thereof is illustrated in FIG. 17.

The method of the disclosure is 7.1 times faster than an existing one while maintaining precision, and an existing technology may have 1.00% probability of failure due to an approximation error of a homomorphic sign function, while the method of the disclosure may have 0.00% probability of failure that is ignorable.

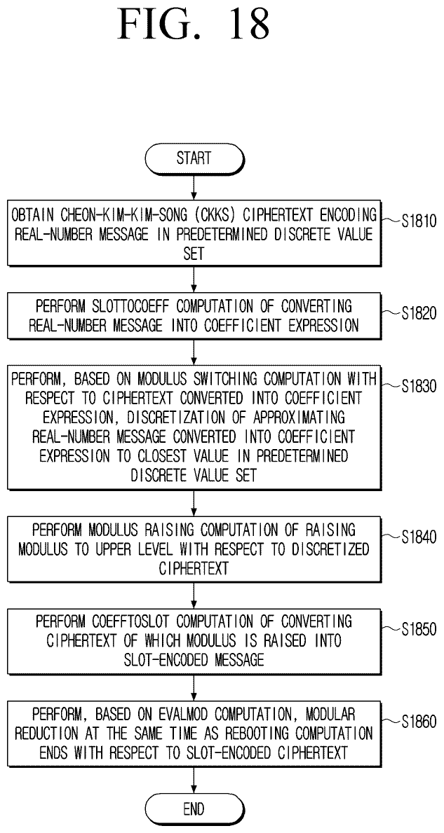

FIG. 18 is a flowchart provided to explain a control method of an electronic apparatus according to one embodiment.

First, a Cheon-Kim-Kim-Song (CKKS) ciphertext encoding a real-number message in a predetermined discrete value set is obtained (S1810). Additionally, SlotToCoeff computation of converting the real-number message into a coefficient expression is performed (S1820). Additionally, based on modulus switching computation with respect to the ciphertext converted into a coefficient expression, discretization of approximating the real-number message converted into a coefficient expression to a closest value in the predetermined discrete value set is performed (S1830). Additionally, modulus raising computation of raising modulus to an upper level with respect to the discretized ciphertext is performed (S1840). Additionally, CoeffToSlot computation of converting the ciphertext of which modulus is raised into a slot-encoded message is performed (S1850). Additionally, based on EvalMod computation, modular reduction at the same time as rebooting computation ends with respect to the slot-encoded ciphertext is performed (S1860).

Additionally, the performing discretization (S1830) may include converting first modulus into second modulus lower than the first modulus with respect to the ciphertext converted into a coefficient expression, and restoring the second modulus to the first modulus to perform discretization.

Additionally, the method may further include performing the discretization to obtain an output message in the predetermined discrete value set.

Additionally, the method may further include performing computation with respect to the output message through a look-up table without polynomial approximation at a time of additional function computation.

Additionally, the method may further include performing bit decomposition with respect to the output message to perform discrete function computation with respect to the output message.

Additionally, the method may further include transmitting the output message to a server.

Additionally, the method may further include displaying the output message.

Further, a scaling factor of the real-number message may be maintained at a first modulus value while the modular reduction is performed.

### REFERENCES

[BCC+22] Y. Bae, J. H. Cheon, W. Cho, J. Kim, and T. Kim. META-BTS: Bootstrapping precision beyond the limit. In CCS, 2022.
[BCKS24] Y. Bae, J. H. Cheon, J. Kim, and D. Stehl'e. Bootstrapping bits with CKKS. In EUROCRYPT, 2024.
[BGGJ20] C. Boura, N. Gama, M. Georgieva, and D. Jetchev. CHIMERA: Combining ring-LWE-based fully homomorphic encryption schemes. J. Math. Crypt., 2020.
[BGV12] Z. Brakerski, C. Gentry, and V. Vaikuntanathan. (Leveled) fully homomorphic encryption without bootstrapping. In ITCS, 2012.
[BKSS24] Y. Bae, J. Kim, D. Stehl'e, and E. Suvanto. Bootstrapping small integers with ckks. In ASIACRYPT, 2024. To appear, available upon request from the authors.
[Bra12] Z. Brakerski. Fully homomorphic encryption without modulus switching from classical GapSVP. In CRYPTO, 2012.
[BZP+23] S. Bian, Z. Zhang, H. Pan, R. Mao, Z. Zhao, Y. Jin, and Z. Guan. HE3DB: An efficient and elastic encrypted database via arithmetic-and-logic fully homomorphic encryption. In CCS, 2023.
[CCKS23] J. H. Cheon, W. Cho, J. Kim, and D. Stehl'e. Homomorphic multiple precision multiplication for CKKS and reduced modulus consumption. In CCS, 2023.
[CGGI16] I. Chillotti, N. Gama, M. Georgieva, and M. Izabach'ene. Faster fully homomorphic encryption: Bootstrapping in less than 0.1 seconds. In ASIACRYPT, 2016.
[CHK+18] J. H. Cheon, K. Han, A. Kim, M. Kim, and Y. Song. Bootstrapping for approximate homomorphic encryption. In EUROCRYPT, 2018.
[CHK+21] J. Cho, J. Ha, S. Kim, B. Lee, J. Lee, J. Lee, S. Moon, and H. Yoon. Transciphering framework for approximate homomorphic encryption. In ASIACRYPT, 2021.
[CKK+19] J. H. Cheon, D. Kim, D. Kim, H. H. Lee, and K. Lee. Numerical method for comparison on homomorphically encrypted numbers. In ASIACRYPT, 2019.
[CKK20] J. H. Cheon, D. Kim, and D. Kim. Efficient homomorphic comparison methods with optimal complexity. In ASIACRYPT, 2020.
[CKKL24] H. Chung, H. Kim, Y.-S. Kim, and Y. Lee. Amortized large look-up table evaluation with multivariate polynomials for homomorphic encryption. IACR eprint 2024/274, 2024.
[CKKS17] J. H. Cheon, A. Kim, M. Kim, and Y. Song. Homomorphic encryption for arithmetic of approximate numbers. In ASIACRYPT, 2017.
[Cry22] CryptoLab. HEaaN library, 2022. Available at https://heaan.it/.
[DM15] L. Ducas and D. Micciancio. FHEW: Bootstrapping homomorphic encryption in less than a second. In EUROCRYPT, 2015.
[DMPS24] N. Drucker, G. Moshkowich, T. Pelleg, and H. Shaul. BLEACH: Cleaning errors in discrete computations over CKKS. J. Cryptol., 2024.
[FV12] J. Fan and F. Vercauteren. Somewhat practical fully homomorphic encryption. Cryptology ePrint Archive, Paper 2012/144, 2012.
[HMWW24] T. Huang, S. Ma, A. Wang, and X. Wang. Approximate methods for the computation of step functions in homomorphic encryption. Cryptology ePrint Archive, Paper 2024/171, 2024.
[JM22] C. S. Jutla and N. Manohar. Sine series approximation of the mod function for bootstrapping of approximate he. In EUROCRYPT, 2022.
[KDE+24] A. Kim, M. Deryabin, J. Eom, R. Choi, Y. Lee, W. Ghang, and D. Yoo. General bootstrapping approach for RLWE-based homomorphic encryption. IEEE Transactions on Computers, 2024.
[LLK+22] J.-W. Lee, Y. Lee, Y.-S. Kim, Y. Kim, J.-S. No, and H. Kang. Highprecision bootstrapping for approximate homomorphic encryption by error variance minimization. In EUROCRYPT, 2022.
[LLKN22] E. Lee, J.-W. Lee, Y.-S. Kim, and J.-S. No. Optimization of homomorphic comparison algorithm on RNS-CKKS scheme. IEEE Access, 2022.
[LLL+21] J.-W. Lee, E. Lee, Y. Lee, Y.-S. Kim, and J.-S. No. High-precision bootstrapping of rns-ckks homomorphic encryption using optimal minimax polynomial approximation and inverse sine function. In EUROCRYPT, 2021.
[LLNK22] E. Lee, J.-W. Lee, J.-S. No, and Y.-S. Kim. Minimax approximation of sign function by composite polynomial for homomorphic comparison. IEEE TDSC, 2022.
[LW24] Z. Liu and Y. Wang. Relaxed functional bootstrapping: A new perspective on bgv/bfv bootstrapping. Cryptology ePrint Archive, Paper 2024/172, 2024.

According to the above embodiments, the electronic apparatus may also perform modular reduction on a real-number message based on discretization.

Meanwhile, the embodiments described above may be implemented with software including instructions stored in a storage medium readable by a machine (e.g., a computer). The machine, as a device capable of calling the stored instructions from the storage media and operating according to the called instructions, may include the electronic apparatus (e.g., electronic apparatus A) according to the disclosed embodiments. Based on instructions executed by a processor, the processor may perform functions corresponding to the instructions directly or by using other elements under the control of the processor. The instructions may include a code generated or executed by a compiler or an interpreter. The machine-readable storage medium may be provided in the form of a non-transitory storage medium. Herein, the term “non-transitory” means that the storage medium does not include a signal and only means that the storage medium is tangible, while the term does distinguish semi-permanent or temporary storage of data in the storage medium.

Additionally, according to the embodiments described above, the method may be provided in a computer program product. The computer program product may be exchanged between a seller and a purchaser as a commodity. The computer program product may be distributed in the form of a machine-readable storage medium (e.g., compact disc read only memory (CD-ROM)) or distributed online through an application store (e.g., Play Store™). In the case of online distribution, at least part of the computer program product may be stored at least temporarily, or generated temporarily in a storage medium such as a manufacturer's server, a server of an application store, or memory of a relay server.

Additionally, the embodiments described above may be implemented in a recording medium readable by a computer or a device similar to a computer by using software, hardware or a combination thereof. In some cases, the embodiments set forth herein may be implemented as a processor itself. In the case of software implementation, the embodiments such as steps and functions set forth herein may be implemented as separate software. Each software may perform one or more functions and operations set forth herein.

Meanwhile, computer instructions for performing processing operations of a device according to the embodiments described above may be stored in a non-transitory computer-readable medium. The computer instructions stored in such a non-transitory computer-readable medium, when executed by a processor of a specific device, cause the specific device to perform the processing operations in the device according to the embodiments described above. The non-transitory computer-readable medium means a medium that stores data semi-permanently and is readable by a machine, rather than a medium such as a register, cache, memory and the like that store data temporarily. Specific examples of the non-transitory computer-readable medium may include a CD, a DVD, a hard disc, a blue-ray disc, a USB, a memory card, ROM, and the like.

Further, each of the elements (e.g., a module or a program) according to the embodiments described above may be comprised of a single entity or a plurality of entities, and some of the corresponding sub elements described above may be omitted, or another sub element may be further included in the embodiments. Alternatively or additionally, some of the elements (e.g., modules or programs) may be integrated into one entity to perform identical or similar functions performed by each corresponding element prior to integration. Operations performed by a module, a program, or another element, according to the embodiments, may be executed sequentially, in parallel, repetitively, or heuristically, or at least some of the operations may be executed in a different order, omitted, or may add a different operation.

While the example embodiments of the disclosure are illustrated and described above, embodiments of the disclosure are not limited to the embodiments set forth herein, and certainly, various modifications thereof may be made by those skilled in the art to which the disclosure pertains, without departing from the scope of the subject matter of the disclosure claimed in the section of claims, and are not to be understood as separating from the technical spirit or prospect of the disclosure.

[Description of Reference Numerals]

| | |
|---|---|
| 100: Electronic apparatus | 110: Memory |
| 120: Processor | 200: Server |

1. An electronic apparatus comprising:
memory storing instructions; and
at least one processor including processing circuitry,
the at least one processor configured to:
obtain a Cheon-Kim-Kim-Song (CKKS) ciphertext encoding a real-number message in a predetermined discrete value set;
perform SlotToCoeff computation of converting the real-number message into a coefficient expression;
perform, based on modulus switching computation with respect to the ciphertext converted into a coefficient expression, discretization of approximating the real-number message converted into a coefficient expression to a closest value in the predetermined discrete value set;
perform modulus raising computation of raising modulus to an upper level with respect to the discretized ciphertext;
perform CoeffToSlot computation of converting the ciphertext of which modulus is raised into a slot-encoded message; and
perform, based on EvalMod computation, modular reduction at the same time as rebooting computation ends with respect to the slot-encoded ciphertext.

2. The electronic apparatus of claim 1,
wherein the at least one processor converts first modulus into second modulus lower than the first modulus with respect to the ciphertext converted into a coefficient expression, and restore the second modulus to the first modulus to perform discretization.

3. The electronic apparatus of claim 1,
wherein the at least one processor performs the discretization to obtain an output message in the predetermined discrete value set.

4. The electronic apparatus of claim 3,
wherein the at least one processor performs computation with respect to the output message through a look-up table without polynomial approximation at a time of additional function computation.

5. The electronic apparatus of claim 3,
wherein the at least one processor performs bit decomposition with respect to the output message to perform discrete function computation with respect to the output message.

6. The electronic apparatus of claim 3 further comprising:
a communication interface,
wherein the at least one processor controls the communication interface to transmit the output message to a server.

7. The electronic apparatus of claim 3 further comprising:
a display,
wherein the at least one processor controls the display to display the output message.

8. The electronic apparatus of claim 1,
wherein a scaling factor of the real-number message is maintained at a first modulus value while the modular reduction is performed.

9. A control method of an electronic apparatus, the method comprising:
obtaining a Cheon-Kim-Kim-Song (CKKS) ciphertext encoding a real-number message in a predetermined discrete value set;
performing SlotToCoeff computation of converting the real-number message into a coefficient expression;
performing, based on modulus switching computation with respect to the ciphertext converted into a coefficient expression, discretization of approximating the real-number message converted into a coefficient expression to a closest value in the predetermined discrete value set;
performing modulus raising computation of raising modulus to an upper level with respect to the discretized ciphertext;
performing CoeffToSlot computation of converting the ciphertext of which modulus is raised into a slot-encoded message; and
performing, based on EvalMod computation, modular reduction at the same time as rebooting computation ends with respect to the slot-encoded ciphertext.

10. The method of claim 9,
wherein the performing discretization includes converting first modulus into second modulus lower than the first modulus with respect to the ciphertext converted into a coefficient expression, and restoring the second modulus to the first modulus to perform discretization.

11. The method of claim 9 further comprising:
performing the discretization to obtain an output message in the predetermined discrete value set.

12. The method of claim 11 further comprising:
performing computation with respect to the output message through a look-up table without polynomial approximation at a time of additional function computation.

13. The method of claim 11 further comprising:
performing bit decomposition with respect to the output message to perform discrete function computation with respect to the output message.

14. The method of claim 11 further comprising:
transmitting the output message to a server.

15. The method of claim 11 further comprising:
displaying the output message.

16. The method of claim 11,
wherein a scaling factor of the real-number message is maintained at a first modulus value while the modular reduction is performed.

17. A non-transitory computer-readable recording medium storing a program for executing an operation method of an electronic apparatus,
the operation method comprising:
obtaining a Cheon-Kim-Kim-Song (CKKS) ciphertext encoding a real-number message in a predetermined discrete value set;
performing SlotToCoeff computation of converting the real-number message into a coefficient expression;
performing, based on modulus switching computation with respect to the ciphertext converted into a coefficient expression, discretization of approximating the real-number message converted into a coefficient expression to a closest value in the predetermined discrete value set;
performing modulus raising computation of raising modulus to an upper level with respect to the discretized ciphertext;
performing CoeffToSlot computation of converting the ciphertext of which modulus is raised into a slot-encoded message; and
performing, based on EvalMod computation, modular reduction at the same time as rebooting computation ends with respect to the slot-encoded ciphertext.
